(19) United States
(12) Patent Application Publication
(10) Pub. No.: US 2002/0128024 A1
(43) Pub. Date: Sep. 12, 2002

(54) Method for announcing and transmitting linked short messages

(76) Inventor: Stefan Pusl, Dorfen (DE)

Correspondence Address: MORRISON & FOERSTER LLP, 2000 PENNSYLVANIA AVE, NW, SUITE 5500, WASHINGTON, DC, 20006-1888, US

(21) Appl. No.: 10/024,530

(22) Filed: Apr. 25, 2002

(30) Foreign Application Priority Data
Dec. 22, 2000 (DE) 10064255.1
Jul. 9, 2001 (DE) 10133257.2

(51) Int. Cl. H04M 11/10; H04Q 7/20

(52) U.S. Cl. 455/466; 455/412

(57) ABSTRACT

The invention relates to a method for announcing and transmitting linked short messages (SMS), preferably in the GSM or UMTS mobile radio system, between a service provider and a mobile radio device.

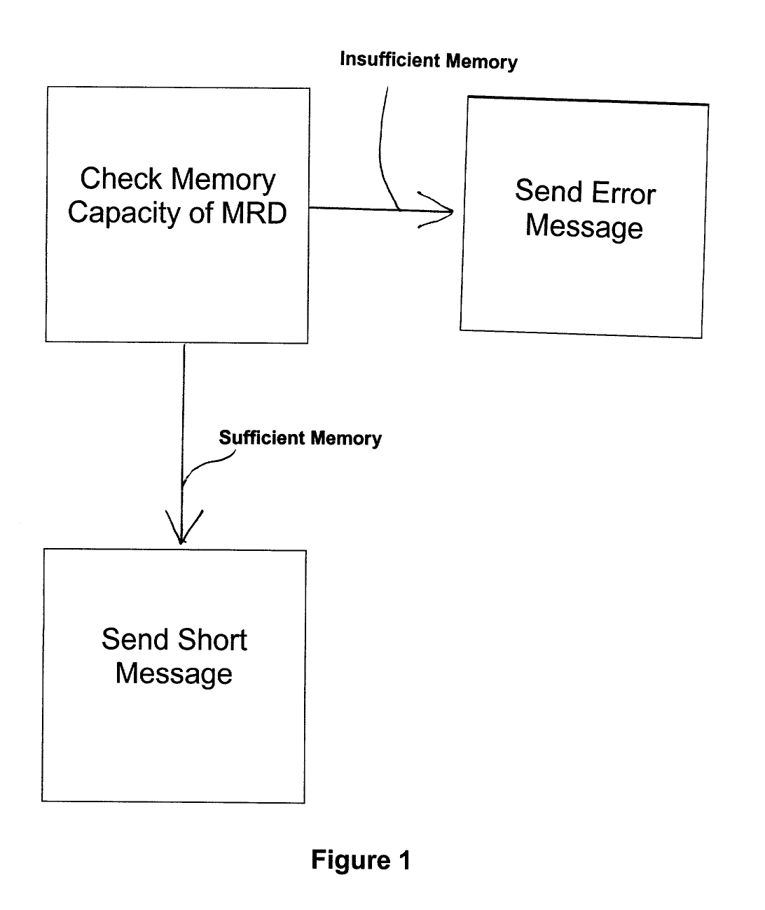

The invention is characterized in that, prior to the transmission of at least two linked short messages to the mobile radio device, the maximum possible memory capacity in the mobile radio device is checked, and the short message is sent in its entirety only after it has been determined that sufficient memory space is available.

The invention relates to a method for announcing and transmitting linked short messages (SMS), preferably in a GSM or UMTS mobile radio system, between a service provider and a mobile radio device.

In the widely-known GSM mobile radio system, and in the mobile radio system of the next generation, UMTS, it is possible to send short messages between the users of these systems utilizing the so-called SMS (Short Message Service). These short messages (SMS) have a maximum length of 160 characters per message. It is necessary to make available a corresponding amount of memory in the receiving mobile radio device for storing this short message. If the mobile radio device does not contain adequate free memory space, for example because too many short messages are already stored in the memory, the received short message, which at this point is only stored in the volatile working memory of the mobile radio device, is not displayed, and an error message is sent to the respective radio network. If the user makes more space available later by deleting one or more messages from the memory, for example, the radio network is automatically informed that the mobile radio device now has free memory for receiving short messages. The network then sends the stored short messages to the respective mobile radio device. The information regarding which short-message centers contain short messages is stored in a known manner in the HLR (Home Location Register) of the mobile radio network.

The maximum 160-character message length does not allow for additional services, however. For this reason, both the GSM and UMTS standards offer the options of logically linking a plurality of short messages. Because the memory for storing short messages in a mobile radio device is limited, the number of linked short messages may be greater than the number of short messages that a mobile radio device can store in its short-message memory based on free memory space.

Consequently, the mobile radio device receives the linked short messages until the short-message memory is full, at which point the mobile radio device cannot display the entire received, linked short message, and cannot receive any further short messages.

It is therefore the object of the invention to disclose a method for announcing and transmitting linked short messages, which allows simple, individual short messages as well as linked short messages to be sent in such a way that they can always be displayed in their entirety on the mobile radio device.

This object is accomplished by the features of claim 1. The dependent claims disclose advantageous modifications of the invention.

Accordingly, the inventor proposes to improve the known method for announcing and transmitting linked short messages, preferably in the GSM or UTMTS mobile radio system, between a service provider and a mobile radio device such that, before at least two linked short messages are sent to the mobile radio device, the maximum possible memory capacity in the mobile radio device is checked, and the short message is sent in its entirety only after it has been ascertained that sufficient memory space is available.

In a modification of the invention, the check of the necessary free memory capacity in the mobile radio network is based on the free memory space reported by the mobile radio device; the check of the necessary free memory capacity preferably takes place in the mobile radio device itself.

It is, however, also possible for the check of the necessary free memory capacity in the mobile radio device to be made with information about the total number of linked short messages in the first short message that has been or is to be transmitted, so the check can be made subsequently in the mobile radio network, for example in the HLR (Home Location Register) or in the SC (Service Center).

Moreover, in an advantageous embodiment of the method, it is proposed that, in the event that insufficient memory capacity is available, the mobile radio device sends an error message to the mobile radio network and a corresponding entry is created in the HLR of the network.

A further embodiment of the method provides that, if sufficient memory capacity is available, the mobile radio device sends a message about the sufficient memory space to the mobile radio network, and the linked short messages are transmitted.

It can also be provided that, in the event of sufficient memory capacity available at a later time, the mobile radio device sends a message about the sufficient memory space to the mobile radio network, and the HLR of the network searches linked short messages that have not yet been sent and transmits them to the available memory space in the mobile radio device.

In accordance with the invention, the information about the amount of free memory can also be transmitted in a so-called deliver report with an RP-ACK message, according to the known protocol, in the connection between the mobile radio device and the base station. This is the response that the mobile radio device sends to the sender when an SMS is announced. This response is preferably transmitted in the user data (TP-UD) or the user-data header (TP-UDH) contained therein.

An exemplary, concrete embodiment of the method in accordance with the invention can be described as follows:

After the mobile radio device has been activated, its sets an internal variable AK to a value that is greater than the total memory space that is available for short messages.

When a short message is received, the mobile radio device ascertains whether this first short message is a portion of a linked short message. If this is the case, the mobile radio device extracts from the message how many linked short messages comprise the entire short message. If sufficient memory space is available, the linked short message is received and stored. If insufficient space is available, the mobile radio device sends an error message to the network with the reason “linked short message exceeds the available short-message storage.” If the number of linked short messages is smaller than AK, AK is overwritten with the smaller number of linked short messages. As soon as at least AK memory space is free in the mobile radio device, the mobile radio device sends a message to the network that free space is available for linked short messages.

In the network, after an error message, “linked short message exceeds the available short-message storage” has been received, an entry is created in a register in the HLR (Home Location Register) with the reason “mobile station memory capacity for concatenated short messages exceeded flag.”

This new entry contains the address SC of the service center. If such an entry is already present, no new entry is created. If a mobile radio device sends a message to the network that free space is available for linked short messages, the HLR informs the various service centers for which the entry with the reason “mobile station memory capacity for concatenated short messages exceeded flag” is present.

With this method, a mobile radio device does not receive linked short messages until it signals that sufficient memory space is available for receiving the entire linked short message.

1. A method for announcing and transmitting linked short messages (SMS), preferably in the GSM or UMTS mobile radio system, between a service provider and a mobile radio device, characterized in that, prior to the transmission of at least two linked short messages to the mobile radio device, the maximum possible memory capacity in the mobile radio device is checked, and the short message is sent in its entirety only after it has been determined that sufficient memory space is available.

2. The method according to claim 1, characterized in that the check of the necessary free memory capacity in the mobile radio network is based on the free memory space indicated by the mobile radio device.

3. The method according to claim 2, characterized in that the check of the necessary free memory capacity takes place in the service center (SC) of a provider.

4. The method according to claim 2, characterized in that the check of the necessary free memory capacity takes place in the Home Location Register (HLR).

5. The method according to claim 1, characterized in that the check of the necessary free memory capacity takes place in the mobile radio device.

6. The method according to one of claims 1 through 5, characterized in that information about the total number of linked short messages in the first short message that has been or is to be transmitted is used for checking the necessary free memory capacity in the mobile radio device.

7. The method according to claim 6, characterized in that, in the case of insufficient memory capacity, the mobile radio device sends an error message to the mobile radio network, and an entry is created in the HLR or SC of the network.

8. The method according to one of claims 6 or 7, characterized in that, in the event of sufficient memory capacity, the mobile radio device sends a message about the sufficient memory space to the mobile radio network, and the linked short messages are transmitted.

9. The method according to one of claims 6 through 8, characterized in that, in the event that sufficient memory capacity is available at a later time, the mobile radio network transmits a message about the sufficient memory space to the mobile radio network, and the HLR or the SC of the network searches linked short messages that have not yet been sent and transmits them to the available memory space in the mobile radio device.

10. The method according to one of claims 1 through 9, characterized in that the information about the amount of free memory space is transmitted in a deliver report of an RP-ACK response, preferably in the user data (TP-UD) or the user-data header (TP-UDH) contained therein.
